(19) United States
(12) Patent Application Publication
(10) Pub. No.: US 2010/0180568 A1
(43) Pub. Date: Jul. 22, 2010

(54) Heat regeneration for a turbofan, a Velarus Propulsion

(76) Inventor: Humberto W. Sachs, Hansville, WA (US)

Correspondence Address: Humberto W. Sachs, 37644 Teel Ln NE, Hansville, WA, 98340, US

(21) Appl. No.: 12/357,530

(22) Filed: Jan. 22, 2009

(51) Int. Cl. F02C 7/10

(52) U.S. Cl. 60/39.511

(57) ABSTRACT

The invention adds details and alternate design supplementing the concept established with my patent application Ser. No. 12/013,431, Aircraft Propulsion System (APS). The APS ultimate fuel economy objectives requires long term design development, and this invention compromises some fuel economy for the expediency of short term implementation of a heat regeneration for turbofans via the re-arrangement of existing components and a few unique items readily designed. While this Velarus Propulsion (VPx) attains only 42% fuel economy, it retains the original APS fundamental architecture implementing heat regeneration for a turbofan engine, as well as the additional benefits of noise and emission abatement. This invention consists of the three APS technologies as follows:
a) A novel arrangement of the power generation core features the turbine exhaust entering directly into the thrust chamber, thus providing heat regeneration with an appropriate configuration of the thrust chamber.
b) The design of a modified combustor introduces the concept of a supersonic nozzle driving the turbines which allows for greater combustor's chamber temperature while injecting the gases at temperatures acceptable to current turbine blade metallurgy. This feature increases the engine thermal efficiency.
c) The hub design allows for two options, a simpler fixed fanblade design or an advanced controllable pitch fan blade, increasing the mission and performance flexibility of a given turbofan size.
   In addition, this invention adds functionality to the aft cone, such as debris purge, accessories installation, and thrust reversers free from hot gases.

### CROSS-REFERENCE TO RELATED APPLICATIONS

Aircraft Propulsion System, patent pending Ser. No. 12/013,431.

### STATEMENT REGARDING FEDERALLY SPONSORED RESEARCH OR DEVELOPMENT

Not Applicable

### REFERENCE TO SEQUENCE LISTING

Not Applicable

### CLASSIFICATION OF THE INVENTION

This invention relates generally to aircraft requiring propulsion.

| | |
|---|---|
| Current U.S. Class: | 244/53R and 62 |
| Current International Class: | IPC8/B 64 D |
| Field of Search: | 244/53R and 62 |
| USA Patents searched | None found comparable |

### BRIEF DESCRIPTION OF THE SEVERAL VIEWS OF THE DRAWING

NA

### LIST OF FIGURES

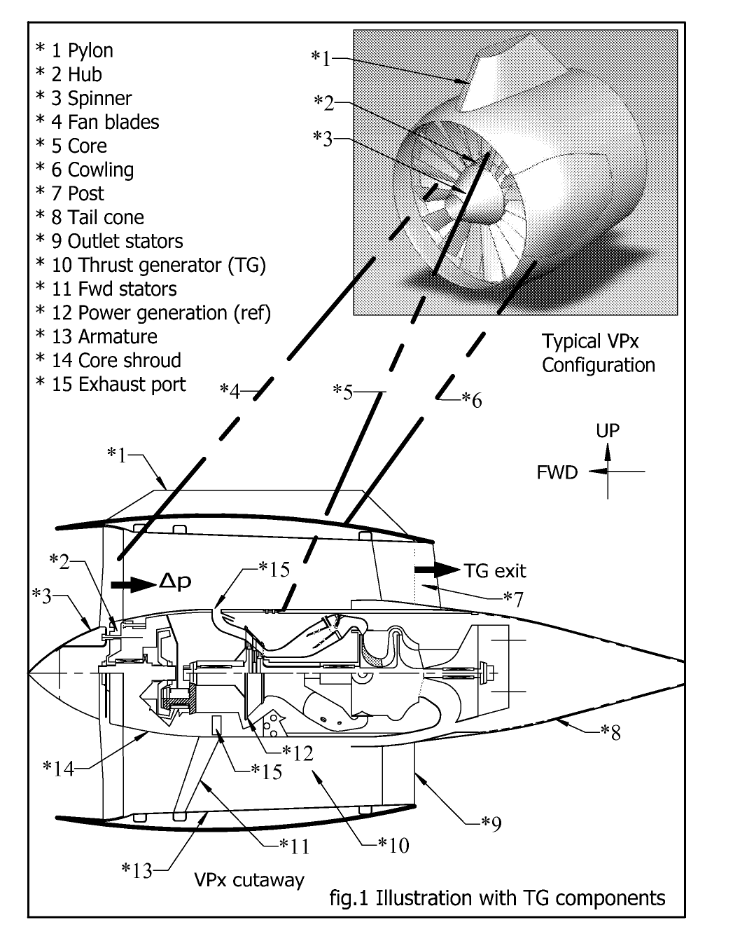

FIG. 1 Illustration with TG components

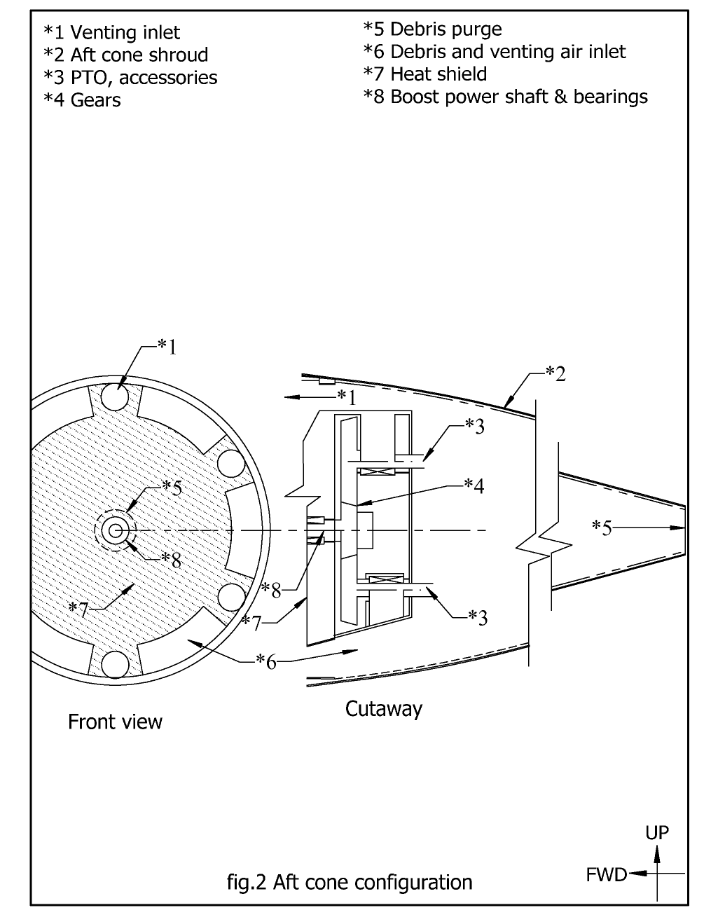

FIG. 2 Aft cone configuration

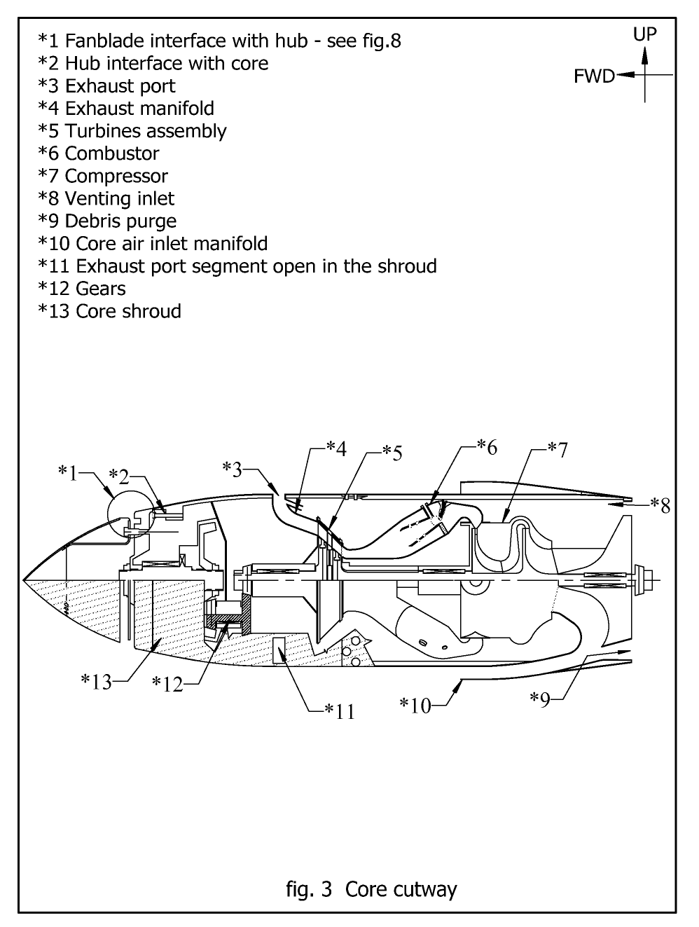

FIG. 3 Core cutaway

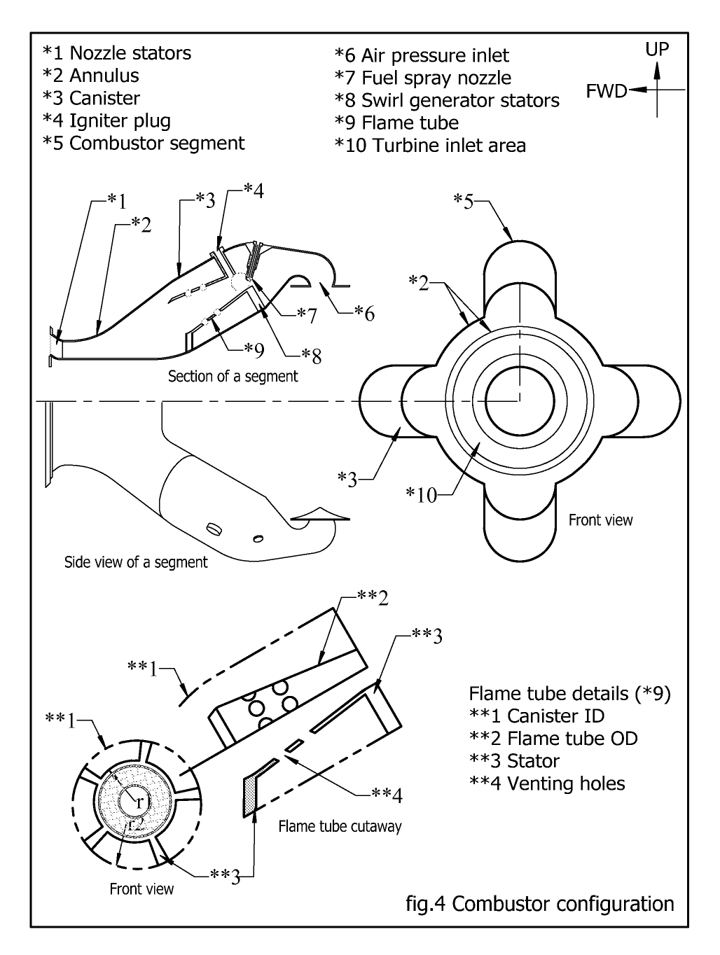

FIG. 4 Combustor configuration

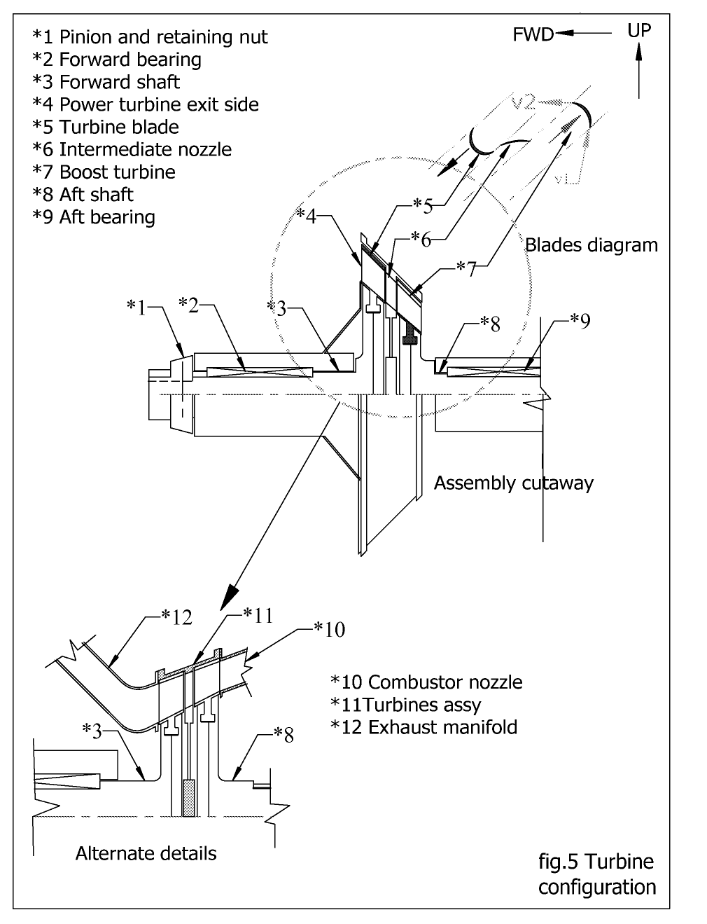

FIG. 5 Turbine configuration

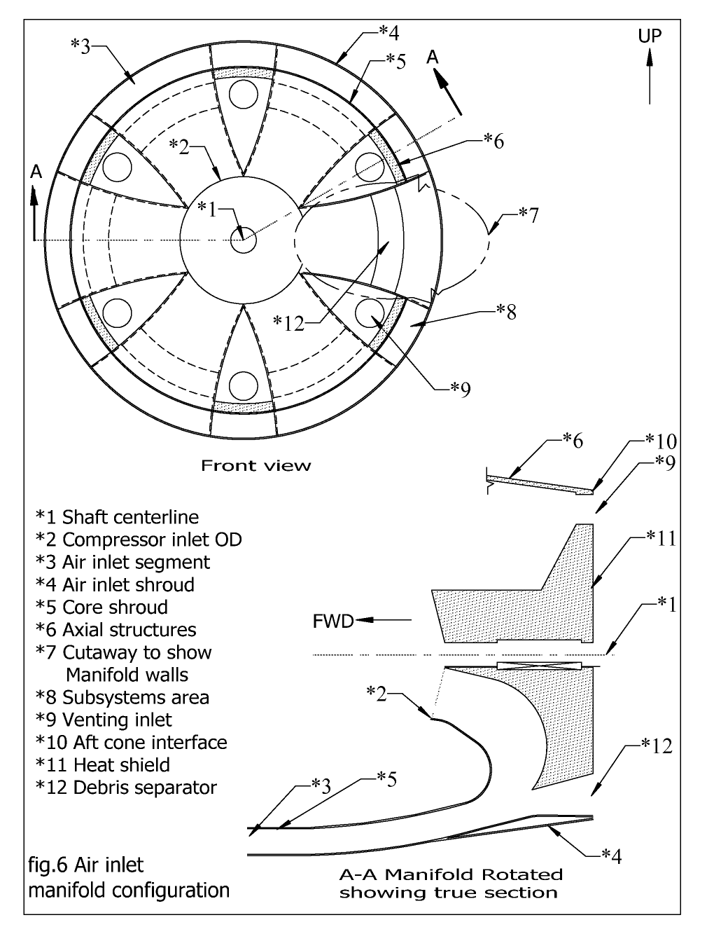

FIG. 6 Air inlet manifold configuration

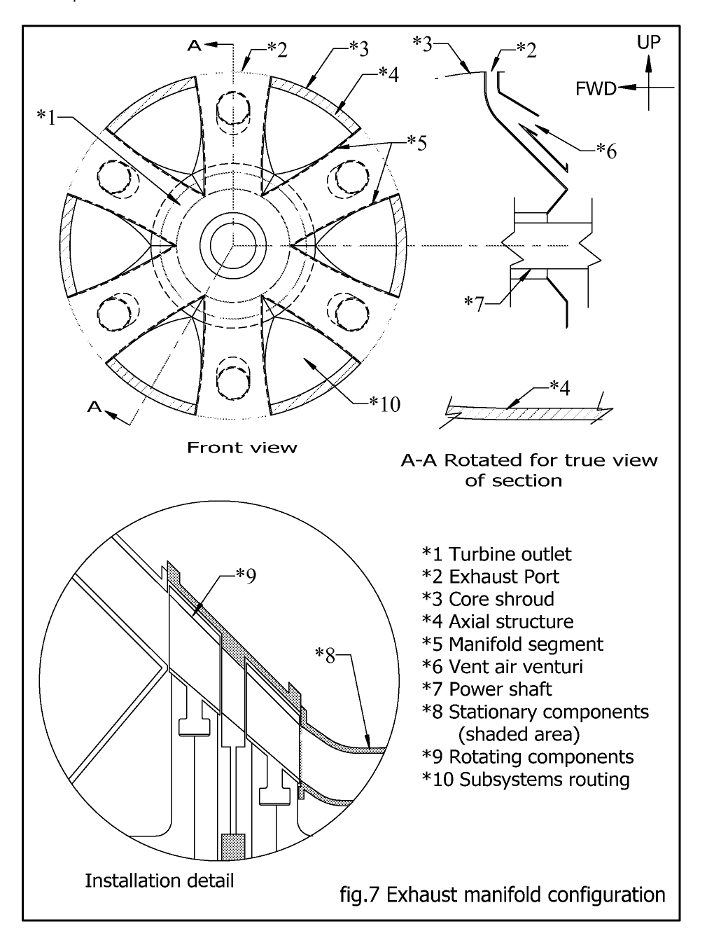

FIG. 7 Exhaust manifold configuration

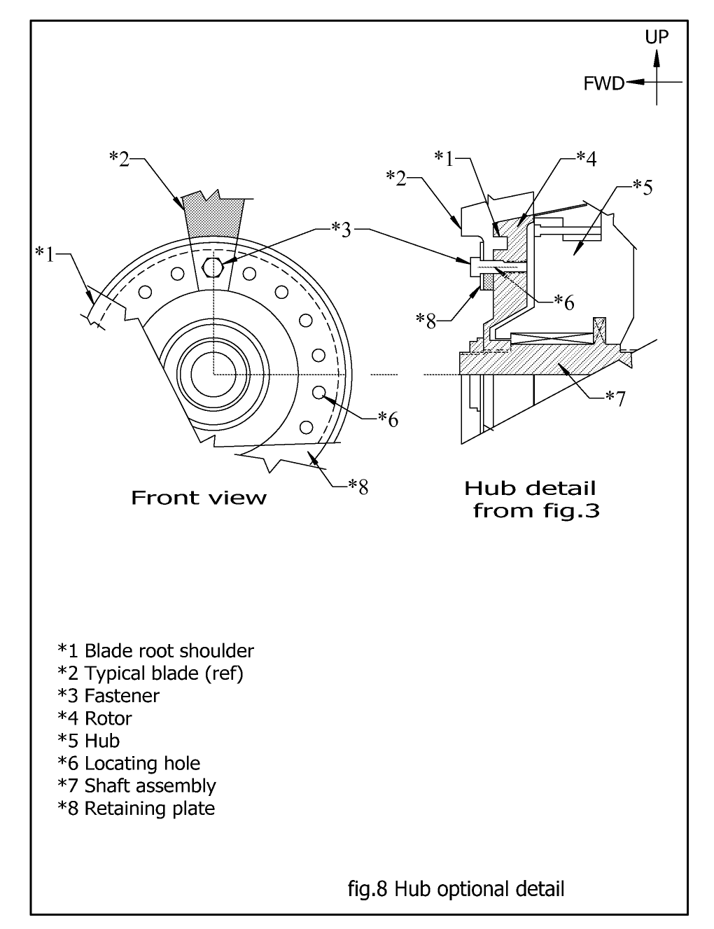

FIG. 8 Hub optional detail

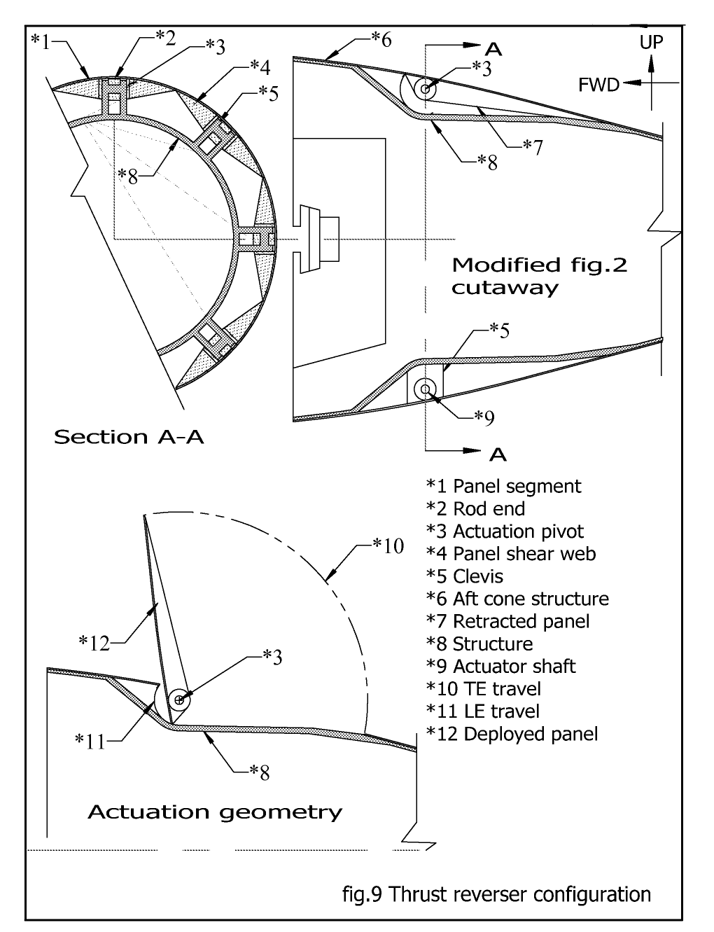

FIG. 9 Thrust reverser configuration

### BACKGROUND OF THE INVENTION

While the GEnx (a General Electric turbofan) claims legitimately to be the next generation of turbofan propulsion, it is the apex of existing technology. Its theoretical thermal efficiency is not innovative and it cannot regenerate waste heat, exhausting the combustion gases above 730° K. While GE significantly increased the fan by-pass over previous engines, an obvious optimization, only heat regeneration can provide the equivalent of 100% by-pass. Therefore, a technology that will allow increased combustion temperature (thus increasing its thermal efficiency) and also will exhaust the gases at temperatures near ambient would, by definition, be the real next generation technology. The VPx meets such criteria. Its combustor design and turbine selection leads to a combustor nozzle design injecting supersonic flow, therefore allowing combustion temperature to 1500° K. or more, while maintaining the turbine inlet temperature (TIT) within metallurgical limits. The heat regeneration provides 100% by-pass fan flow, with up to 39% increase in thrust compared to the same turbofan with current technology.

Combined, the two innovations (heat regeneration and combustor efficiency) justify a claim for fuel saving of more than 40% even compared to the GEnx. A radical new architecture introduced by the referenced APS with greater fuel saving goals, is now modified to allow an easier implementation. The referenced patent pending Ser. No. 12/013,431 and this invention complement each other.

### REFERENCE DATA USED FOR BACKGROUND RESEARCH

With more than 40 years aerospace experience, I am certain there is absolutely nothing engineered similar to the unique VPx architecture. Of course, I am familiar with the fundamentals of all existing aircraft propulsion systems and proposed hypersonic future designs. Searching the USPTO database, I could not find any relevant patent referring to turbofan heat regeneration. A few references to turbine heat regeneration published on the Internet are closed cycle design not applicable to aircraft propulsion and not relevant to this invention's opened cycle heat regeneration. While the power generation has some similarities with the gas generator of typical turboprop engines, this invention's architecture is not implementable without the unique designs of the air inlet and exhaust manifolds.

### BRIEF SUMMARY OF THE INVENTION

This invention consists of a turbofan engineered with a unique core architecture which integrates several desirable technologies and functions, including the capability to regenerate the turbine's exhaust heat. It is composed of two major modules, the thrust generator (TG) and the power generation core. The unique overall feature of this invention is the turbofan's thrust being entirely due to the TG, instead of the fan being just a by-pass air flow as established by current culture.

The initial propulsion thrust is generated by air flow spun by high speed fanblades inducing whirling of the air stream which develops an increase in the absolute air flow pressure (ΔP in FIG. 1), in accordance with current technology. Near the fanblade trailing edge, the exhaust heat from the turbine is injected via segmented ports into the whirling air flow in the thrust chamber, mixing and accelerating the air flow similar to an afterburner. This accelerated air stream is then guided by the nozzle exhausting via outlet stators, providing the thrust gain that characterizes this invention. The hot gases mixed with the fan airstream results in an increase in the total air flow temperature in the appropriately configured thrust chamber. Note that one degree Kelvin rise in the fanned air produces approximately one kilowatt of power per kg of air flow, now converted into thrust.

The key technology of the power generation characterizing this invention consists of a modified combustor, the arrangement of the turbines which is similar to typical turboprop engines, and the configuration (design) of the air inlet and exhaust manifolds. These manifolds are essential to the heat regeneration implementation and their geometry and location also allow the design of a bay in the aft cone to house auxiliary equipment and deliver other specific functions.

### Claim

What is claimed and desired to be secured by Letters Patent of the United States is the invention of a turbofan with an opened cycle heat regeneration, supplementing the referenced APS patent' claims. The uniqueness of this invention is embodied in the VPx architecture, configuration and functional integration providing the user with the benefit of fuel economy combined with lower emission of pollutants and noise. This invention provides alternate design to the generic APS to achieve thrust generation without a tail jet nozzle, a most significant departure from today's fanjet design.

This invention may be installed in existing or incorporated into new aircraft design, subsonic or supersonic. Furthermore, it is here claimed that the VPx architecture facilitates the design of more efficient combustors, an effective debris purge subsystem, and allows for the engine accessories to be housed in the aft cone, significantly simplifying the engine design, including the installation of a simpler thrust reverser option.

Claim details

Therefore, I claim that this invention will deliver propulsion with significant fuel economy compared to existing turbofans while reducing manufacturing and ownership costs. The fuel economy is complemented with lower noise and contaminants pollution than existing designs without the need for add-on equipment. This claim is warranted because the invention enables regeneration of the turbine exhaust and waste heat while increasing the engine's thermal efficiency. These benefits are achievable with the invention's architecture in accordance with the claim stated in paragraph 13.
a. Without the weight and volume penalty typical of industrial heat regeneration, the unique architecture of the VPx allows for an efficient and simple method to achieve heat regeneration, thus avoiding the thermal loss classic with jet nozzles in the tail of current turbofans.
b. The combustor design may or may not implement the unique features of this invention. Its unique optional feature is characterized by a supersonic nozzle configured with guide vanes allowing for greater thermal efficiency while incorporating impulse turbine technology. It requires this invention's flame tube.
c. An essential element of this invention, the architecture of the turbines arrangement and location allows the injection of turbine exhaust directly into the whirling air stream in the thrust generator (TG) via porting in the core's shroud.
d. The VPx architecture facilitates the implementation of a combustor characterized by higher temperature in its chamber, thus increasing the machine thermodynamic efficiency.
e. The design of the air inlet manifold is another essential element of this invention, allowing the heat regeneration technology to be implemented while facilitating the design of a debris purge subsystem (foreign object damage protection) without the need for filtering or other add-on equipment.
f. The design of the exhaust manifold is another essential element of this invention allowing the heat regeneration technology to be implemented and facilitating the injection of cooling waste (venting) into the TG.
g. The VPx architecture permits the integration of auxiliary components directly connected to the boost turbine shaft and housed in the aft cone, simplifying manufacturing and startup procedures, similar to a turboprop. While the components are standard design, their installation in the aft cone of a turbofan is here claimed as an element of this invention.
h. The aft cone and inlet manifold integration allows for the design of an efficient venting system. As a side benefit, the aft cone now free from high temperature exhaust gases, can house a robust and simple thrust reverser. While the detail design of the thrust reverser is standard mechanical engineering, its configuration and location is here claimed as an element of this invention.
k. The supplemental details of the fanblade's root attachment to the rotor and the flame tube design are also options available to the VPx designer, and are here claimed as elements of this invention, facilitating manufacturing and improving the longevity of the components.

### OBJECTIVES AND SUMMARY OF THE INVENTION

The embodiment of this invention is to deliver an efficient, fuel and cost effective turbofan compared to current propulsion systems, including turbo-prop. It is also the goal of this technology to reduce pollution of both, contaminants and noise without the design of special equipment or attachments to the basic engine. This is achieved naturally with the architecture of the VPx and details of this invention.

### DETAILED DESCRIPTION OF THE INVENTION

The specific architecture, configuration and functional details composing the embodiment of this invention allows for the VPx propulsion to be used in new aircraft design or to replace the propulsion units on existing aircraft. The airframe's appropriate design of the cowling inlet duct will make the VPx suitable for subsonic or supersonic flight. The major functional modules of the invention consists of the thrust generator (FIG. 1), the aft cone (FIG. 2) and the power generation modules in the core (FIG. 3) which includes reference to the generic hub. To improve clarity, the illustrations do not include the customary and standard structures consisting of beams, shear webs, cylinders and ribs. The illustrations intend to communicate the invention's essential layout and geometry necessary to implement the heat regeneration concept.

Referring to the cutaway in FIG. 1, the principal components of the TG includes its fanblades (*4) attached to a hub (*2), the turbine exhaust port (*15), a post (*7), the outlet and forward stators (*9 & *11) located around the engine core (*14) and within an armature (*13) connected to a cowling (*6), which in turn is supported by a pylon (*1) or other traditional interface with the aircraft. The spinner (*3) and the aft cone (*8) aid the air flow in and out of the TG. None of these components in itself is unique to this invention, except the exhaust port critical location in the core's shroud and distribution of the exhaust around its perimeter. The claim in paragraph 14 refers to this overall configuration of the TG providing the sole thrust generation, a major departure from today's technology.

The cowling and the pylon are reference only, being an arbitrary airframe design suitable to a particular aircraft. The hub is an integral design of the power generation interface with the fanblades. The standard spinner guides the air into the fanblades. Motorized via the rotor embedded in the hub, the fanblades develop the typical absolute pressure increase (Δp) and the induced swirl in the propelled air mass as with any turbofan engine.

An essential feature of this invention, notice that the injection of the exhaust heat into the TG nozzle, located quite forward from the outlet stators, is responsible for most of the propulsion gain over existing designs. Similar to an after-burner, the added heat into the appropriately configured TG and outlet stators accelerates the fanned air mass, delivering the increase in propulsion thrust.

The core is structurally attached to the armature by the outlet and forward stators, as with any turbofan engine. Yet, the VPx installation allows for an optional post detail which may carry fuel, lubricants, electrical and signal cables into the core.

Attached to the core, an aft cone facilitates the installation of accessories via a gear box and power takeoff shafts (PTO) protected by a heat shield (*7) as illustrated in FIG. 2, similar to a turboprop. While there is nothing new about such equipment (standard starter/generator, etc.), its installation in the aft cone of a turbofan is a novel configuration which allows the direct drive connection with the boost power shaft, a significant design simplification compared to current technology. It also allows for low power requirement turning only the compressor to initialize engine startup. This structural tail cone functionality is another feature of this invention.

Furthermore, this cone configuration also allows for debris in the air inlet to enter the cone (*6) and then be ejected directly into the environment (*5) without possibility of damaging the outlet stators as is normally done. Since the air inlet into the aft cone is much larger than the debris purge area, the circulating air reenters the core (*1) providing the required venting to the power generation module. This particular debris ejection and venting configuration is claimed in paragraph 14 as another feature of this invention. As seen in the exhaust manifold (FIG. 7), after serving as a coolant, this now hot venting air is injected back into the TG, thus not wasted.

This invention locates the turbofan's power generation within the core (FIG. 3) as all jet engines do, but it is designed with its unique architecture as claimed in paragraph 14. The essential core components affected by the VPx architecture includes compressors (*7), combustors (*6), turbines (*5), air inlet manifold (*10), and exhaust manifold (*4). The module is completed with standard hardware such as bearings, gears, and rotor motorizing the hub interface (*1) with the fanblades, wrapped within the cylindrical core shroud (*13).

While the illustrations depict a two-stage centrifugal compressor, typical of small turbofan, the requirement for air compression may be achieved by any arrangement of axial and centrifugal design. Such standard components selection is not relevant for this invention, while their locations between the turbines and the aft cone, as well as its orientation delivering the compressed air forwardly are features of this invention and claimed in paragraph 14 solely because of the uniqueness of the inlet and exhaust manifolds.

Referring to FIG. 3, the core cutaway includes areas depicting the side view on the opposite half of the center-line to illustrate the geometry and specifically shows the segmented exhaust port outlet through the shroud (*11) because structural integrity cannot afford a continuous opening in the shroud. Yet, the depiction of the air inlet area is entirely a section to show the asymmetry of the inlet ducts and the structures between two manifold segments (see FIG. 6).

The combustor design allows higher combustor chamber temperature than current design via the implementation of a supersonic nozzle and a ceramic flame tube. Referring to FIG. 4, the combustor assembly may be any combination of can (tubular) or annular geometry but the illustration shows a possible configuration to illustrate the significant elements that modifies standard design due to the implementation of the VPx technology claimed with this invention.

The nozzle stators (*1) leading edge must start within the subsonic air speed range of the accelerating combustion mixture, and their trailing edge should coincide with the supersonic nozzle injection into the turbine inlet. This feature, combined with the flame tube and swirl stators (items *9 and *8) now to be manufactured with high temperature ceramic, deliver the innovative characteristic of a higher temperature combustor than current state of the art, as claimed in paragraph 14.

The geometry of the one-piece flame tube (flame tube cutaway in FIG. 4) with an enlarging diameter starting and ending with stators which slide inside the canister (*3) requiring no fasteners, it is novel by its particularities which allows the flame tube to be manufactured with ceramic and claimed in paragraph 14 as a feature of this invention. The particularities of the flame tube consist of its conical shape and eccentricity with respect to the canister. The flame tube front view illustrates the eccentricity (r1/r2) and the cutaway illustrates its conical shape and thick walls allowing for the diagonal holes (*4) whirling effect. This design details allow for the flame tube installation without the need for fasteners, while the eccentricity makes it impervious to inducement of rotation. The absence of fasteners and loading the ceramic in compression are essential requirements for ceramic's integrity and longevity.

While ceramic have been used for other kinds of combustors, its implementation with an aircraft turbine is innovative because until now the ordinary subsonic combustor exit temperature limited by the TIT did not require ceramic implementation. For example, the maximum TIT is about 1000° K. with current metallurgy. For a standard subsonic nozzle, this limitation restricts the combustor temperature to less than 1300° K., thus not requiring ceramic. With the VPx technology, for the same TIT and a combustor exit at about Mach 1.75, the combustor temperature can be 1500° K., thus the need for innovative design using ceramic (until other high temperature materials are discovered).

Referring to FIG. 5, the turbines (two or more) also are uniquely configured by this invention. The location of the turbines allows their exhaust to be guided into the TG (*4) instead of wasting the heat out the jet nozzle classic with today's engines. The boost turbine or set of turbines have the shaft extended aft (*8) driving the compressor or compressors. The power turbine or set of turbines has the shaft (*3) extended forward, driving the pinion (*1) and gear reduction to motorize the fanblades. The power turbine rotates opposite to the boost turbine, thus minimizing the necessary angular deflection of the relative flow within the intermediate nozzle or guide vanes (*6). To achieve such layout, a unique air inlet and exhaust manifolds were designed to comply with their natural functionality while not jeopardizing the structural integrity of the engine core. In addition, the manifolds facilitate the installation of an accessories bay and debris purging in the aft cone.

This turbine arrangement (or layout) characterizes this invention in accordance with the claims in paragraph 14, while the actual design of the turbine, vanes, rotor, and bearings details are standard technology.

While the turbines are depicted with a rising angle toward the exhaust manifold, this is not a requirement for the implementation of this invention. See the alternate details. The shape or form of the turbine bank is irrelevant to the effect of this invention, except for the fact that the exhaust must flow in the opposite direction of today's jet nozzle, a pre-requisite for the heat regeneration implementation and an essence of this patent's claims. This feature is also depicted in the alternate details showing a radial turbine assembly imposing changes to the exhaust manifold and combustor nozzle while retaining the fundamental architecture that characterizes this invention: the exhaust gases enter the TG shortly after the fanblades trailing edge.

Referring to FIG. 6, the front view illustrates the configuration of the air inlet manifold allowing for the segmented inlet areas (*3) between the two cylindrical shrouds (*4 & *5) to be ducked (*7), guiding the air to enter the compressor's inlet outer diameter (*2) as a continuous stream. Between the manifold segments and the two shrouds, an area (*8) is available for subsystems routing (electrical, plumbing, etc.). Between any two manifold segments and inside the core shroud (*6), space is allocated for axial structures (such as longeron or beam) as well as for holes (*9) allowing passage of the air returning from the aft cone. In the center, the boost power shaft (*1) forms the compressor's inlet inner diameter mating with the manifold. The view also shows the open area (*12) in the back wall of the manifold allowing for purged debris to enter the aft cone.

The manifold section view in FIG. 6 illustrates the required continuity for the air inlet duct while it centrifugally separates debris from the air stream directed toward the compressor's inlet. On the opposite side of the center-line, the section depicts the structural segment between the ducts and the venting inlet. It also shows the possibility of locating a bearing supported by the heat shield and the manifold structure.

While the number and size of the manifold segments are dictated by a specific machine size and flow requirements, the configuration of segmented air inlets reversing the air flow and providing a continuous, streamlined compressor inlet supply is another novel feature of this invention. Equally novel are the concepts of allocated space for the axial structures, subsystem area and debris purge featured by this manifold configuration.

Referring to FIG. 7, the front view of the exhaust manifold illustrates the design of segmented ducts necessary to channel the turbine waste energy into the TG. From an annular turbine exit (*1), the ducts collect the exhaust gas and directs it toward the segmented ports (*2) in the core's shroud. These ports take advantage of venturi suction to optimize the turbine performance. Each manifold segment (*5) provides a venturi suction to collect the venting air (*6). Between the manifold segments, a triangular space allows for axial structures (*4) and subsystems routing (*10), maintaining structural integrity of the core similar to the air inlet manifold.

While the number and size of the exhaust manifold segments are dictated by a specific machine size and flow requirements, an essence of the invention is the manifold configuration feature providing a continuous free flow of the waste heat into the TG, in accordance with the claims in paragraph 14. The layout shown in the installation detail in the enlarged view clarifies the integration of the exhaust manifold with other fixed equipment housing the rotating turbines to demonstrate that existing design standards are applicable here, despite the novel arrangement.

Referring to FIG. 8, this hub detail is an enlargement of item *1 from FIG. 3. While the hub design (*5) itself is standard hardware housing bearings, interfacing with the core shroud, and supporting the rotor (*4), the rotor interface (*3) with the fanblade (*2) may also be standard, with the option shown in this detail. The shaft power (*7) is transferred via splines or similar mechanical device to the rotor. In this VPx optional detail, the fixed fanblade is located by a root shoulder (*1) in the rotor and fastened (*3) in a sandwich between the rotor and a retaining plate (*8). While only one fastener per blade may be sufficient for loads, fail safety is achieved by multiple fasteners around the retaining plate (*8). This feature is a productivity enhancement per claim in paragraph 14.

While the mechanism is standard technology (hydraulic or electrical actuation), FIG. 9 depicts a thrust reverser configuration that the VPx designer may option to implement. Referring to the section AA of FIG. 9, the hatched area of each panel segment (*1) identifies the actuating assembly segments while the shaded area shows the continuity required for the support structure (*8).

Each thrust reverser segment hinges about a pivot (*3) as shown in the actuation geometry. The retracted panel (*7) flares with the aft cone shroud. When deployed, it reverses the fanned air providing a negative thrust. A mounting cylinder (*8) maintains the structural integrity of the aft cone (*6) as well as supports the mechanism (not depicted) and actuating surface via devises (*5) or similar hardware. Installed in the aft cone and free from hot gases, the invention includes this novel thrust reverser architecture, which can be built with low weight, high strength graphite composites.

In flight, such device actuation could be modulated, hence usable also for rapid descent, replacing traditional spoilers. Jet fighters could use it for high “g′s” maneuver.

1. What is claimed and desired to be secured by Letters Patent of the United States is the invention of a turbofan with an opened cycle heat regeneration, supplementing the Aircraft Propulsion System (APS—Ser. No. 12/013,431) patent' claims. The uniqueness of this invention is embodied in this Velarus Propulsion (VPx) architecture, configuration and functional integration providing the user with a more efficient turbofan engine than current technology. This invention provides alternate designs to the generic APS to achieve thrust generation without a tail jet nozzle, a most significant departure from today's fanjet design. This invention may be installed in existing or incorporated into new aircraft design, subsonic or supersonic.

2. Without the weight and volume penalty typical of industrial heat regeneration, the unique architecture of the VPx allows for an efficient and simple method to achieve heat regeneration, thus avoiding the thermal loss typical with turbofan's jet nozzles. An essential element of this invention, the architecture of the turbines arrangement combined with the unique exhaust manifold design injects the turbine exhaust directly into the whirling air stream in the thrust generator (TG) via porting in the core's shroud, thus augmenting the thrust generated by the fanblades.

3. Although the designer may or may not implement the high temperature combustor, I also claim the uniqueness of such combustor characterized by a supersonic nozzle. It requires the flame tube designed with this invention. The higher combustion temperature increases the engine's thermal efficiency.

4. Furthermore, it is here claimed that this VPx architecture simplifies the engine design because of its effective debris purge subsystem integrated with the inlet manifold and the aft cone. The design of the air inlet manifold, another essential element of this invention, allows the heat regeneration technology to be implemented while facilitating the design of a debris purge subsystem (foreign object damage protection) without the need for filtering or other add-on equipment.

5. The aft cone and inlet manifold integration facilitates the design of an efficient venting system. As a side benefit, the aft cone, now free from high temperature exhaust gases, can house a robust and simple thrust reverser. While the detail design of the thrust reverser is standard mechanical engineering, its configuration and location is here claimed as an element of this invention.

6. Also, the designer may implement the novel, optional fanblade, turbine and compressor's blade root attachment shown with this design, here claimed to simplify the engine's manufacturing.

7. Therefore, I claim that this invention will deliver aircraft propulsion with significant fuel economy compared to existing turbofans while reducing manufacturing and ownership costs. The fuel economy is complemented with lower noise and contaminants pollution than existing designs without the need for add-on equipment. This claim is warranted because the invention enables regeneration of the turbine exhaust and waste heat while also increasing the turbines thermal efficiency.
